(19) United States
(12) Patent Application Publication
(10) Pub. No.: US 2025/0289955 A1
(43) Pub. Date: Sep. 18, 2025

(54) DUCTILE FLAME-RETARDANT POLYAMIDE COMPOSITIONS AND USES THEREOF, IN PARTICULAR FOR RAILWAYS

(71) Applicant: ARKEMA FRANCE, Colombes (FR)

(72) Inventors: Florent ABGRALL, SERQUIGNY (FR); Jean-Jacques FLAT, SERQUIGNY (FR); Marjorie MARCOURT, SERQUIGNY (FR)

(73) Assignee: ARKEMA FRANCE, Colombes (FR)

(21) Appl. No.: 18/860,687

(22) PCT Filed: Apr. 28, 2023
(86) PCT No.: PCT/FR2023/000061

§ 371 Date: Oct. 27, 2024

(30) Foreign Application Priority Data
Apr. 28, 2022 (FR) FR2203980

(51) Int. Cl. C08L 77/02; B61D 49/00; C08K 5/5313

(52) U.S. Cl. CPC C08L 77/02; B61D 49/00; C08K 5/5313; C08L 2201/02; C08L 2205/03; C08L 2205/06

(57) ABSTRACT

A flame-retardant composition including, by weight:
(a) from 30% to 85% by weight of at least one semicrystalline aliphatic polyamide having an inherent viscosity ranging from 1.2 to 1.6, as determined according to the standard ISO 307:2007 but while using m-cresol instead of sulfuric acid, a temperature of 20° C. and a concentration of 0.5% by weight,
(b) from 10% to 30% by weight of at least one phosphinate flame retardant,
(c) from 5% to 20% of at least one functionalized polyolefin,
(d) from 2% to 8% of at least one plasticizer,
(e) from 0 to 10% of at least one additive.

The present invention relates to ductile flame-retardant polyamide compositions and the use thereof, notably for railroad applications and the preparation of tubes, in particular corrugated tubes.

The railroad field tends to use materials having a high mechanical strength and good resistance to aging.

More recently, the materials used in trains have had to meet technical requirements in terms of fire resistance. These requirements depend on the type of object and its use in the train. The EN 45545 standard sets various specifications depending on the material category. Polyamide tubes correspond to the R22 and R23 categories.

Products are classified according to their limiting oxygen index and also the density and toxicity of the smoke that they generate during combustion. Three classifications, HL1, HL2 or HL3, can be achieved depending on their fire properties.

The higher this classification, the more the product can be used in a large type of train, whereas a product classified as HL1 cannot be used in an underground subway train, for example.

These days, the HL2 category covers most of the existing market and is the objective targeted in general, which means in particular a limiting oxygen index (LOI)>28.

Beyond this fire resistance, the materials used in trains are also subjected to numerous mechanical stresses that cover the following properties:
flexibility: the modulus must be between 500 and 1200 MPa,
flexibility/bendability: ability to deform a tube without cracking, associated with behavior at the yield point (low stress and high elongation)
breaking strength: the tensile elongation at break must be greater than 100%
impact strength over a temperature range extending to −30° C.,
fatigue strength.

These properties must be maintained over time. The products must therefore be capable of withstanding accelerated thermal aging for several days at 150° C.

Finally, the polyamide must remain easy to process by extrusion, which limits the viscosity that the formulation may have.

The prior art already describes flame-retardant formulations, like in application US20170037198, which describes formulations for the railroad field focusing specifically on a PA12 matrix.

However, these formulations do not meet all the requirements listed above, in particular for mechanical properties.

Still in the railroad field, international application WO 2013/092302 deals with glass-fiber reinforced polyamides flame-retarded with a melamine derivative.

Lastly, application US 2007/0021535 combines the use of phosphinate, melamine cyanurate and polyol as a flame retardant for a polyamide.

However, the same drawbacks relating to the requirements listed above, in particular for the mechanical properties, remain.

New products must therefore be developed to enable good protection of the equipment and passengers in the event of fire.

A more complete formulation having an improved compromise, in particular an optimum, between mechanical strength and fire resistance is therefore required.

The present invention therefore relates to a flame-retardant composition comprising, by weight:
(a) from 30% to 85% by weight, for example from 33% to 83% by weight, in particular from 50% to 78.9% by weight, of at least one semicrystalline aliphatic polyamide having an inherent viscosity ranging from 1.2 to 1.6, notably from 1.2 to 1.5, in particular from 1.3 to 1.5, notably strictly less than 1.5, notably ranging from 1.30 to 1.48, as determined according to the standard ISO 307:2007 but while using m-cresol instead of sulfuric acid, a temperature of 20° C. and a concentration of 0.5% by weight,
(b) from 10% to 30% by weight, for example from 10% to 25% by weight, for example from 14% to 25% by weight, for example from 14% to 22% by weight, for example from 17% to 22% by weight of at least one phosphinate flame retardant,
(c) from 5% to 20%, in particular from 5% to 15%, of at least one functionalized polyolefin,
(d) from 2% to 8% by weight, in particular from 2% to 6% by weight, of at least one plasticizer,
(e) from 0 to 10% by weight, in particular from 0.1% to 5% by weight, of at least one additive.

The inventors have therefore found that a semicrystalline aliphatic polyamide, in particular proportions and having a particular inherent viscosity, combined at least with a phosphinate flame retardant, with a functionalized polyolefin and with a plasticizer, all three also being in a particular proportion, and optionally with an additive, made it possible to form a composition meeting all the requirements listed above.

The viscosity of the semicrystalline aliphatic polyamide matrix is essential, in particular, for the fatigue strength. An inherent viscosity that is too low, i.e. less than 1.2, will not have sufficient fatigue strength. Compositions based on semicrystalline aliphatic polyamide with a viscosity of less than 1.2 would thus have mechanical properties which are insufficient for the intended application, in particular for an application as a tube, notably a corrugated tube, for a railroad application. Compositions based on semicrystalline aliphatic polyamide with a viscosity of less than 1.2 would in particular have insufficient fatigue strength. The fatigue strength can notably be measured by a Ross flex test as described in the examples. Compositions in accordance with the invention, namely comprising in particular a semicrystalline aliphatic polyamide with a viscosity greater than 1.2, advantageously make it possible to satisfy this test, that is to say to prepare bars which are not broken after 400 000 cycles, according to the Ross flex test described in the examples.

A viscosity that is too high, notably greater than 1.6, will no longer allow the composition to be shaped, notably in the form of a corrugated tube.

Compositions based on semicrystalline aliphatic polyamide with a viscosity notably greater than 1.6 could not in particular be extruded at standard shaping temperatures, in particular at temperatures below or equal to 350° C., preferably below or equal to 320° C., preferably between 170° C. and 300° C., for example between 200° C. and 280° C.

Such compositions would have to be extruded at significantly higher temperatures and/or with higher shear rates, which would have the effect of impacting in particular the fire resistance properties of the resulting tube, the flame retardant being at least partially or even completely, degraded under such processing conditions. These compositions would thus have fire resistance properties which are insufficient for the intended application, in particular for an application as a tube, notably a corrugated tube, for a railroad application. Compositions based on semicrystalline aliphatic polyamide of excessively high viscosity, notably greater than 1.6, would in particular have a limiting oxygen index (LOI) lower than the desired value in order to satisfy standard EN 45545 for categories R22 and R23. Compositions in accordance with the invention, namely comprising in particular a semicrystalline aliphatic polyamide with a viscosity of less than 1.6, preferably less than 1.5, preferably strictly less than 1.5, advantageously make it possible to satisfy this test, as illustrated in the examples.

The plasticizer range makes it possible to provide the composition with a sufficiently low modulus without compromising the cold impact strength.

Compositions comprising less than 2% by weight of plasticizer relative to the total weight of the composition might thus have mechanical properties which are insufficient for the intended application, in particular for an application as a tube, notably a corrugated tube, for a railroad application. Compositions comprising less than 2% by weight of plasticizer relative to the total weight of the composition might in particular have an excessively high tensile modulus, notably a tensile modulus of greater than 1200 MPa, this parameter being measured as described in the examples. Compositions in accordance with the invention, namely comprising in particular at least 2% by weight of plasticizer relative to the total weight of the composition, advantageously make it possible to attain satisfactory mechanical properties, notably a tensile modulus of less than 1200 MPa, this parameter being measured as described in the examples.

Compositions comprising more than 8% by weight of plasticizer relative to the total weight of the composition might themselves have mechanical properties which are insufficient for the intended application, in particular for an application as a tube, notably a corrugated tube, for a railroad application. Compositions comprising more than 8% by weight of plasticizer relative to the total weight of the composition might in particular have a cold notched impact strength of less than 5 kJ/m², this parameter being measured as described in the examples. Compositions in accordance with the invention, namely comprising in particular up to 8% by weight of plasticizer relative to the total weight of the composition, advantageously make it possible to attain satisfactory mechanical properties, notably a cold notched impact strength of greater than or equal to 5 kJ/m², this parameter being measured as described in the examples.

The functionalized polyolefin range makes it possible to obtain good fatigue strength and/or good cold impact strength, without excessively increasing the fire sensitivity of said composition.

Compositions comprising less than 5% by weight of functionalized polyolefin relative to the total weight of the composition would thus have mechanical properties which are insufficient for the intended application, in particular for an application as a tube, notably a corrugated tube, for a railroad application. Compositions comprising less than 5% by weight of functionalized polyolefin relative to the total weight of the composition would have in particular a cold notched impact strength of less than 5 kJ/m², this parameter being measured as described in the examples. Compositions in accordance with the invention, namely comprising in particular at least 5% by weight of functionalized polyolefin relative to the total weight of the composition, advantageously make it possible to attain satisfactory mechanical properties, notably a cold notched impact strength of greater than or equal to 5 kJ/m², this parameter being measured as described in the examples.

Compositions comprising more than 20% by weight of functionalized polyolefin relative to the total weight of the composition would furthermore have fire resistance properties which are insufficient for the intended application, in particular for an application as a tube, notably a corrugated tube, for a railroad application. Compositions comprising more than 20% by weight of functionalized polyolefin relative to the total weight of the composition would in particular have a limiting oxygen index (LOI) lower than the desired value in order to satisfy standard EN 45545 for categories R22 and R23. Compositions in accordance with the invention, namely comprising in particular a functionalized polyolefin in a content of less than 20% by weight, relative to the total weight of the composition, advantageously make it possible to satisfy this test, as illustrated in the examples. The flame retardant range as defined according to the invention itself makes it possible to obtain sufficient fire resistance, and notably to enable compositions to be obtained that have in particular a limiting oxygen index (LOI) greater than the desired value in order to satisfy standard EN 45545 for categories R22 and R23, while maintaining satisfactory mechanical properties, in particular without excessively weakening the product. Compositions comprising less than 10% by weight of flame retardant relative to the total weight of the composition generally do not make it possible to attain the desired value in order to satisfy standard EN 45545 for categories R22 and R23, as defined in the examples. Compositions comprising more than 30% by weight of flame retardant relative to the total weight of the composition might themselves have insufficient mechanical properties, in particular a cold notched impact strength of less than 5 kJ/m², this parameter being measured as described in the examples. Compositions in accordance with the invention, namely comprising in particular up to 30% by weight of flame retardant relative to the total weight of the composition, preferably up to 25% by weight, in particular up to 22% by weight, advantageously make it possible to attain satisfactory mechanical properties, notably a cold notched impact strength of greater than or equal to 5 kJ/m², this parameter being measured as described in the examples.

It is therefore a compromise, in particular an optimum, which can only be achieved by the particular selection of the ranges of the various constituents of the composition.

Advantageously, said composition is intended for a railroad application.

The invention also covers the use of compositions as defined according to the invention for the manufacture of flame-retardant articles, notably tubes, intended for railroad applications, and notably intended for applications in trains.

### Regarding the Semicrystalline Aliphatic Polyamide (a)

The compositions of the invention comprise at least one semicrystalline aliphatic polyamide having an inherent viscosity between from 1.2 to 1.6, notably from 1.2 to 1.5, in particular from 1.3 to 1.5, as determined according to the standard ISO 307:2007 but while using m-cresol instead of sulfuric acid, a temperature of 20° C. and a concentration of 0.5% by weight.

According to one embodiment, the compositions of the invention comprise at least one semicrystalline aliphatic polyamide having an inherent viscosity strictly less than 1.5, notably ranging from 1.30 to 1.48, as determined according to the standard ISO 307:2007 but while using m-cresol instead of sulfuric acid, a temperature of 20° C. and a concentration of 0.5% by weight.

Said at least one semicrystalline aliphatic polyamide (a) is present in a content ranging from 30% to 85% by weight, notably from 33% to 83% by weight, in particular from 50% to 78.9% by weight, relative to the total weight of the composition.

A semicrystalline polyamide is understood to mean a material which is generally solid at room temperature and which softens during a temperature increase, in particular after passing its glass transition temperature (Tg), and which can melt sharply when passing its so-called melting temperature (Tm), and which becomes solid again when the temperature decreases below its crystallization temperature.

The Tg, the Tc and the Tm are determined by differential scanning calorimetry (DSC) according to the standards 11357-2:2013 and 11357-3:2013 respectively.

The number-average molecular mass Mn of said semicrystalline polyamide is preferably in a range of from 10 000 to 85 000, in particular from 10 000 to 60 000, preferentially from 10 000 to 50 000 and even more preferentially from 12 000 to 50 000.

The nomenclature used to define the polyamides is described in the standard ISO 1874-1:2011, “Plastics—Polyamide (PA) moulding and extrusion materials—Part 1: Designation”, in particular on page 3 (tables 1 and 2) and is well known to those skilled in the art.

The term polyamide embraces both homopolyamides and copolyamides.

Said at least one semicrystalline aliphatic polyamide is obtained from the polycondensation of at least one lactam, or from the polycondensation of at least one amino acid, or from the polycondensation of at least one diamine X with at least one dicarboxylic acid Y or mixtures thereof.

When said at least one semicrystalline aliphatic polyamide is obtained from the polycondensation of at least one lactam, said at least one lactam may be chosen from a C6 to C18, preferentially C9 to C18, more preferentially C10 to C18, more preferentially C10 to C11 lactam. A C8 to C18 lactam is in particular decanolactam or undecanolactam.

When said at least one semicrystalline aliphatic polyamide is obtained from the polycondensation of at least one lactam, it can thus comprise a single lactam or several lactams.

When said at least one semicrystalline aliphatic polyamide is obtained from the polycondensation of at least one amino acid, said at least one amino acid may be chosen from a C6 to C18, preferentially C9 to C18, more preferentially C10 to C18, more preferentially C10 to C11 amino acid.

A C6 to C18 amino acid is in particular 9-aminononanoic acid, 10-aminodecanoic acid and 11-aminoundecanoic acid, and also derivatives thereof, in particular N-heptyl-11-aminoundecanoic acid.

When said at least one semicrystalline aliphatic polyamide is obtained from the polycondensation of at least one amino acid, it can thus comprise a single amino acid or several amino acids.

Advantageously, said semicrystalline aliphatic polyamide is obtained from the polycondensation of a single amino acid and said amino acid is chosen from 10-aminodecanoic acid and 11-aminoundecanoic acid, advantageously 11-aminoundecanoic acid.

When said at least one aliphatic semicrystalline polyamide is obtained from the polycondensation of at least one C4-C36, preferentially C6-C18, preferentially C6-C12, more preferentially C10-C12 diamine X, with at least one C4-C36, preferentially C6-C18, preferentially C6-C12, more preferentially C10-C12, diacid Y, then said at least one diamine X is an aliphatic diamine and said at least one diacid Y is an aliphatic diacid.

The diamine may be linear or branched. Advantageously, it is linear.

Said at least one C4-C36 diamine X may be chosen in particular from 1,4-butanediamine, 1,5-pentanediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine, octadecenediamine, eicosanediamine, docosanediamine and diamines obtained from fatty acids.

Advantageously, said at least one diamine X is C6-C18 and is chosen from 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine.

Advantageously, said at least one C6 to C12 diamine X is chosen in particular from 1,6-hexamethylenediamine, 1,7-heptamethylenediamine, 1,8-octamethylenediamine, 1,9-nonamethylenediamine, 1,10-decamethylenediamine, 1,11-undecamethylenediamine and 1,12-dodecamethylenediamine.

Advantageously, the diamine X used is a C10 to C12 diamine, in particular chosen from 1,10-decamethylenediamine, 1,11-undecamethylenediamine and 1,12-dodecamethylenediamine.

Said at least one C4 to C36 dicarboxylic acid Y can be chosen from succinic acid, glutaric acid, adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid and diacids obtained from fatty acids.

The diacid may be linear or branched. Advantageously, it is linear.

Advantageously, said at least one dicarboxylic acid Y is a C6-C18 dicarboxylic acid and is chosen from adipic acid, suberic acid, azelaic acid, sebacic acid, undecanedioic acid, dodecanedioic acid, brassylic acid, tetradecanedioic acid, pentadecanedioic acid, hexadecanedioic acid and octadecanedioic acid.

Advantageously, said at least one dicarboxylic acid Y is a C6-C12 dicarboxylic acid and is chosen from adipic acid, suberic acid, azelaic acid, sebacic acid, undecanedioic acid and dodecanedioic acid.

Advantageously, said at least one dicarboxylic acid Y is C10-C12 dicarboxylic acid and is chosen from sebacic acid, undecanedioic acid and dodecanedioic acid.

When said semicrystalline aliphatic polyamide is obtained from the polycondensation of at least one diamine X with at least one dicarboxylic acid Y, it may thus comprise a single diamine or several diamines and a single dicarboxylic acid or several dicarboxylic acids.

Advantageously, said semicrystalline aliphatic polyamide is obtained from the polycondensation of a single diamine X with a single dicarboxylic acid Y.

In one embodiment, said at least one polyamide is a long-chain polyamide having a number of carbons per nitrogen atom of greater than or equal to 8, in particular greater than or equal to 9, notably greater than or equal to 10.

In another embodiment, said at least one semicrystalline aliphatic polyamide is chosen from the polyamides PA610, PA612, PA1010, PA1012 and PA11.

Advantageously, said at least one semicrystalline aliphatic polyamide is chosen from the polyamides PA1010, PA1012 and PA11, notably PA11.

According to one embodiment, the semicrystalline aliphatic polyamide of the invention may be a polyether block amide (PEBA).

The polyether block amides (PEBA) are copolymers containing amide units (Ba1) and polyether units (Ba2), said amide unit (Ba1) corresponding to an aliphatic repeating unit chosen from a unit obtained from at least one amino acid or a unit obtained from at least one lactam, or a unit X·Y obtained from the polycondensation:
of at least one diamine, said diamine being chosen from a linear or branched aliphatic diamine, and
of at least one dicarboxylic acid, said diacid being an aliphatic diacid, said polyether units (Ba2) being obtained in particular from at least one polyalkylene ether polyol, in particular a polyalkylene ether diol.

According to one embodiment, the semicrystalline aliphatic polyamide according to the invention is not a polyether block amide (PEBA).

According to one embodiment, the semicrystalline aliphatic polyamide according to the invention is not a PA12.

### Regarding the Phosphinate Flame Retardant (b)

A composition according to the invention must contain an amount of phosphinate flame retardant (b) sufficient to give said composition the desired fire resistance properties, and in particular a classification at the HL2 or even HL3 hazard level, according to standard EN 45545, and preferably a classification at the HL2 hazard level according to standard EN 45545.

Said at least one phosphinate flame retardant (b) may be present in a content of at least 10% by weight, for example at least 14% by weight, for example at least 15% by weight, for example at least 17% by weight, relative to the total weight of the composition.

An excessively small amount of phosphinate flame retardant (b) does not make it possible to achieve sufficient fire resistance properties, and notably does not make it possible to achieve a classification at the HL2 or even HL3 hazard level, according to standard EN 45545, and in particular a classification at the HL2 hazard level according to standard EN 45545.

The phosphinate flame retardant (b) must not be present in excessively large proportions either, at the risk of negatively impacting the mechanical properties. Thus, the phosphinate flame retardant (b) is generally present in a content of at most 40% by weight, typically up to 30% by weight, relative to the total weight of the composition.

Too high an amount of phosphinate flame retardant (b) can have negative effects on the mechanical properties, and notably can decrease the tensile strength and/or impact strength and/or fatigue strength.

According to one embodiment, the phosphinate flame retardant (b) is present in a content ranging from 10% to 30% by weight, for example from 10% to 25% by weight, for example from 14% to 25% by weight, for example from 14% to 22% by weight, for example from 17% to 22% by weight, relative to the total weight of the composition. For example, said at least one phosphinate flame retardant (b) may be present in a content ranging from 14% to 20% by weight relative to the total weight of the composition.

The flame retardant is in particular a metal salt chosen from a metal salt of phosphinic acid, a metal salt of diphosphinic acid, a polymer containing at least one metal salt of phosphinic acid or a polymer containing at least one metal salt of diphosphinic acid. The flame retardant can also be a mixture of the abovementioned flame retardants.

The flame retardant can also be chosen from the metal salt of phosphinic acid of formula (I) below and the metal salt of diphosphinic acid of formula (II) below:

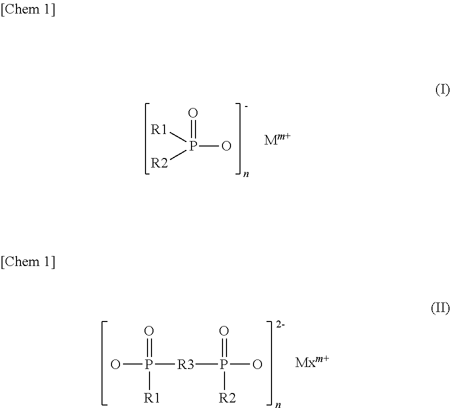

with
R1 and R2, independently of each other, denoting a linear or branched C1-C6 alkyl group or an aryl group;
R3 representing a linear or branched C1-C10 alkylene, C6-C10 arylene, C6-C10 alkylarylene or C6-C10 arylalkylene group,
M being an Mg, Ca, Al, Sb, Sn, Ge, Ti, Zn, Fe, Zr, Ce, Bi, Sr, Mn, Li, Na or K ion and/or a protonated amine base,
m denoting an integer from 1 to 4,
n denoting an integer from 1 to 4,
x denoting an integer from 1 to 4,
n and m being chosen such that the salt is neutral, i.e. such that it does not bear an electrical charge.

Preferably, M represents a calcium, magnesium, aluminum or zinc ion.

Preferably, R1 and R2, independently of each other, denote a methyl, ethyl, n-propyl, isopropyl, n-butyl, tert-butyl, n-pentyl and/or phenyl group.

Preferably, R3 represents a methylene, ethylene, n-propylene, isopropylene, n-butylene, tert-butylene, n-pentylene, n-octylene, n-dodecylene; phenylene, naphthylene; methylphenylene, ethylphenylene, tert-butylphenylene, methylnaphthylene, ethylnaphthylene, tert-butylnaphthylene; phenylmethylene, phenylethylene, phenylpropylene or phenylbutylene group.

According to one embodiment, the flame retardant may be an aluminum diethyl phosphinate. By way of example of such compounds, mention may notably be made of the product Exolit OP1311 sold by Clariant.

### Regarding the Functionalized Polyolefin (c)

A composition according to the invention must contain an amount of functionalized polyolefin sufficient to give said composition the mechanical properties desired for the intended application, in particular good fatigue strength.

Said at least one functionalized polyolefin (c) is present from 5% to 20% by weight, in particular from 5% to 15% by weight, relative to the total weight of the composition.

The functionalized polyolefin may be a polymer of alpha olefins having reactive units (the functionalities); such reactive units are the acid, anhydride or epoxy functions. By way of example, mention may be made of non-functionalized polyolefins grafted or copolymerized or terpolymerized with unsaturated epoxides, such as glycidyl (meth)acrylate, or with carboxylic acids or the corresponding salts or esters, such as (meth)acrylic acid (it being possible for the latter to be completely or partially neutralized with metals such as Zn, etc.), or else with carboxylic acid anhydrides, such as maleic anhydride.

A non-functionalized polyolefin is conventionally a homopolymer or copolymer of alpha-olefins or diolefins, for instance ethylene, propylene, 1-butene, 1-octene or butadiene. Examples that may be mentioned include:
polyethylene homopolymers and copolymers, in particular LDPE, HDPE, LLDPE (linear low density polyethylene), VLDPE (very low density polyethylene) and metallocene polyethylene;
propylene homopolymers or copolymers,
   ethylene/alpha-olefin such as ethylene/propylene, EPR (abbreviation for ethylene-propylene-rubber) and ethylene-propylene-diene (EPDM) copolymers;
      styrene/ethylene-butene/styrene (SEBS), styrene/butadiene/styrene (SBS), styrene/isoprene/styrene (SIS) and styrene/ethylene-propylene/styrene (SEPS) block copolymers;
copolymers of ethylene with at least one product chosen from salts or esters of unsaturated carboxylic acids, such as alkyl (meth)acrylate (for example methyl acrylate), or vinyl esters of saturated carboxylic acids, such as vinyl acetate (EVA), it being possible for the proportion of comonomer to be up to 40% by weight.

A functionalized polyolefin is, for example, a PE/EPR blend, the weight ratio of which can vary within broad limits, for example between 40/60 and 90/10, said mixture being cografted with an anhydride, notably maleic anhydride, with a degree of grafting of, for example, from 0.01 to 5% by weight.

The functionalized polyolefin may be chosen from the following (co)polymers grafted with maleic anhydride or glycidyl methacrylate, in which the degree of grafting is, for example, from 0.01% to 5% by weight:
PE, PP, copolymers of ethylene with propylene, butene, hexene or octene containing, for example, from 35% to 80% by weight of ethylene;
ethylene/alpha-olefin such as ethylene/propylene, EPR (abbreviation for ethylene-propylene-rubber) and ethylene-propylene-diene (EPDM) copolymers;
   styrene/ethylene-butene/styrene (SEBS), styrene/butadiene/styrene (SBS), styrene/isoprene/styrene (SIS) and styrene/ethylene-propylene/styrene (SEPS) block copolymers;
copolymers of ethylene and vinyl acetate (EVA), containing up to 40% by weight of vinyl acetate;
copolymers of ethylene and alkyl (meth)acrylate, containing up to 40% by weight of alkyl (meth)acrylate;
copolymers of ethylene and vinyl acetate (EVA) and alkyl (meth)acrylate, containing up to 40% by weight of comonomers.

The functionalized polyolefin may also be chosen from majority-propylene ethylene/propylene copolymers which are grafted with maleic anhydride and then condensed with monoaminated polyamide (or a polyamide oligomer) (products described in EP-A-0342066).

The functionalized polyolefin may also be a co- or terpolymer of at least the following units: (1) ethylene, (2) alkyl (meth)acrylate or saturated carboxylic acid vinyl ester and (3) anhydride, such as maleic or (meth)acrylic acid anhydride, or epoxy, such as glycidyl (meth)acrylate.

As examples of functionalized polyolefins of the latter type, mention may be made of the following copolymers, where ethylene preferably represents at least 60% by weight and where the termonomer (the function) represents, for example, from 0.1% to 10% by weight of the copolymer:
ethylene/alkyl (meth)acrylate/(meth)acrylic acid or maleic anhydride or glycidyl methacrylate copolymers;
ethylene/vinyl acetate/maleic anhydride or glycidyl methacrylate copolymers;
ethylene/vinyl acetate or alkyl (meth)acrylate/(meth)acrylic acid or maleic anhydride or glycidyl methacrylate copolymers.

In the preceding copolymers, the (meth)acrylic acid can be salified with Zn or Li.

The term “alkyl (meth)acrylate” denotes C1 to C8 alkyl methacrylates and acrylates, and may be chosen from methyl acrylate, ethyl acrylate, n-butyl acrylate, isobutyl acrylate, 2-ethylhexyl acrylate, cyclohexyl acrylate, methyl methacrylate and ethyl methacrylate.

Moreover, the abovementioned functionalized polyolefins can also be crosslinked by any appropriate process or agent (diepoxy, diacid, peroxide, etc.); the term functionalized polyolefin also includes mixtures of the abovementioned polyolefins with a difunctional reagent such as diacid, dianhydride, diepoxy, etc. capable of reacting with them, or mixtures of at least two functionalized polyolefins capable of reacting with each other.

The copolymers mentioned above may be copolymerized randomly or sequentially and may have a linear or branched structure.

The molecular weight, the MFI index and the density of these polyolefins may also vary within a broad range, as those skilled in the art will appreciate. MFI is the abbreviation for the melt flow index. It is measured according to the standard ASTM 1238.

In one embodiment, the polyolefin is crosslinked.

According to one embodiment, the functionalized polyolefin may be chosen from polyethylene homopolymers and copolymers, in particular LDPE, HDPE, LLDPE (linear low density polyethylene), VLDPE (very low density polyethylene) and metallocene polyethylene, and in particular from VLDPE (very low density polyethylene).

By way of example of such compounds, mention may notably be made of the product Orevac IM800 sold by SK Functional Polymer.

According to one embodiment, the functionalized polyolefin may be chosen from ethylene/alkyl(meth)acrylate/(meth)acrylic acid or maleic anhydride or glycidyl methacrylate copolymers; ethylene/vinyl acetate/maleic anhydride or glycidyl methacrylate copolymers; ethylene/vinyl acetate or alkyl (meth)acrylate/(meth)acrylic acid or maleic anhydride or glycidyl methacrylate copolymers.

By way of example of such compounds, mention may notably be made of the product Lodater AX8900 sold by SK Functional Polymer.

### Regarding the Plasticizer (d)

Said at least one plasticizer (e) may be present at from 2% to 8% by weight, in particular from 2% to 6% by weight, relative to the total weight of the composition.

The plasticizer can be a plasticizer commonly used in compositions based on polyamide(s).

Advantageously, use is made of a plasticizer which exhibits good thermal stability in order for fumes not to be formed during the stages of blending the various polymers and of transformation of the composition obtained.

In particular, this plasticizer can be chosen from:
benzenesulfonamide derivatives, such as n-butylbenzenesulfonamide (BBSA), the ortho and para isomers of ethyltoluenesulfonamide (ETSA), N-cyclohexyltoluenesulfonamide and N-(2-hydroxypropyl)benzenesulfonamide (HP-BSA),
esters of hydroxybenzoic acids, such as 2-ethylhexyl para-hydroxybenzoate (EHPB) and 2-hexyldecyl para-hydroxybenzoate (HDPB),
esters or ethers of tetrahydrofurfuryl alcohol, such as oligoethyleneoxy-tetrahydrofurfuryl alcohol, and
esters of citric acid or of hydroxymalonic acid, such as oligoethyleneoxy malonate.

A preferred plasticizer is n-butylbenzenesulfonamide (BBSA).

Another more particularly preferred plasticizer is N-(2-hydroxypropyl)benzenesulfonamide (HP-BSA). This is because the latter exhibits the advantage of preventing the formation of deposits at the extrusion screw and/or die (“die drool”) during a stage of transformation by extrusion.

Use may very obviously be made of a mixture of plasticizers.

### Regarding the Additives (e)

Said at least one additive (f) may be present at from 0% to 10% by weight, in particular from 0.1% to 5% by weight, relative to the total weight of the composition.

The at least one additive may be chosen from stabilizers, dyes, adjuvants assisting in the transformation (processing aids), surfactants, nucleating agents, pigments, brighteners, antioxidants, lubricants, waxes, flame retardancy synergists, or a mixture thereof.

Advantageously, the at least one additive is chosen from antioxidants, colored pigments and flame retardancy synergists, in particular melamine-based nitrogen synergists.

By way of example, the stabilizer may be a UV stabilizer, an organic stabilizer or more generally a combination of organic stabilizers, such as a phenol-type antioxidant (for example of the Irganox® 245, 1098 or 1010 type from BASF), a phosphite-type antioxidant (for example Irgafos® 126 or Irgafos® 168 from BASF) and even optionally other stabilizers such as a HALS, which stands for hindered amine light stabilizer (for example Tinuvin® 770 from BASF), a UV absorber (for example Tinuvin® 312 from BASF) or a phosphorus-based stabilizer. Use may also be made of antioxidants of amine type such as Naugard® 445 from Crompton or else of polyfunctional stabilizers such as Nylostab® S-EED from Clariant.

This stabilizer may also be a mineral stabilizer, such as a copper-based stabilizer. Examples of such mineral stabilizers include copper halides and acetates. Secondarily, other metals such as silver may possibly be considered, but these are known to be less effective. These copper-based compounds are typically combined with alkali metal halides, in particular potassium halides.

The flame-retardancy synergists are in particular as described in WO2005121234.

They may be chosen from nitrogen synergists and phosphorus/nitrogen synergists.

The nitrogen synergists preferably comprise benzoguanamine, tris(hydroxyethyl)isocyanurate, allantoin, glycoluril, melamine, melamine cyanurate, dicyandiamide, guanidine and carbodiimides.

The nitrogen synergists preferably comprise melamine condensation products. By way of example, the melamine condensation products are melem, melam or melon, or compounds of this type with a higher degree of condensation, or else a mixture of these, and, by way of example, can be prepared by the process described in U.S. Pat. No. 5,985,960.

The phosphorus/nitrogen synergists may comprise reaction products of melamine with phosphoric acid or with condensed phosphoric acids, or may comprise reaction products of melamine condensation products with phosphoric acid or condensed phosphoric acids, or else may comprise a mixture of the specified products.

In one embodiment, the additives are chosen from antioxidants, colored pigments and flame retardancy synergists, notably nitrogen synergists, in particular melamine-based synergists.

### Regarding the Composition

According to one embodiment, the flame-retardant composition comprises, by weight:
(a) from 30% to 85% by weight, for example from 33% to 83% by weight, in particular from 50% to 78.9% by weight, of at least one semicrystalline aliphatic polyamide having an inherent viscosity ranging from 1.2 to 1.6, notably from 1.2 to 1.5, in particular from 1.3 to 1.5, notably strictly less than 1.5, notably ranging from 1.30 to 1.48, as determined according to the standard ISO 307:2007 but while using m-cresol instead of sulfuric acid, a temperature of 20° C. and a concentration of 0.5% by weight,
(b) from 10% to 30% by weight, for example from 10% to 25% by weight, for example from 14% to 25% by weight, for example from 14% to 22% by weight, for example from 17% to 22% by weight, for example from 14% to 20% by weight, of at least one phosphinate flame retardant,
(c) from 5% to 20%, in particular from 5% to 15%, of at least one functionalized polyolefin,
(d) from 2% to 8% by weight, in particular from 2% to 6% by weight, of at least one plasticizer,
(e) from 0% to 10% by weight, in particular from 0.1% to 5% by weight, of at least one additive,
the sum of the constituents (a) to (e) being equal to 100% by weight.

According to one embodiment, the composition comprises, by weight:
(a) from 30% to 85% by weight, for example from 33% to 83% by weight, in particular from 50% to 78.9% by weight, of at least one semicrystalline aliphatic polyamide having an inherent viscosity ranging from 1.2 to 1.6, notably from 1.2 to 1.5, in particular from 1.3 to 1.5, notably strictly less than 1.5, notably ranging from 1.30 to 1.48, as determined according to the standard ISO 307:2007 but while using m-cresol instead of sulfuric acid, a temperature of 20° C. and a concentration of 0.5% by weight,
(b) from 10% to 30% by weight, for example from 10% to 25% by weight, for example from 14% to 25% by weight, for example from 14% to 22% by weight, for example from 17% to 22% by weight, for example from 14% to 20% by weight, of at least one phosphinate flame retardant,
(c) from 5% to 20%, in particular from 5% to 15%, of at least one functionalized polyolefin,
(d) from 2% to 8% by weight, in particular from 2% to 6% by weight, of at least one plasticizer,
(e) from 0% to 10% by weight, in particular from 0.1% to 5% by weight, of at least one additive,
said composition excluding PA12.

According to one embodiment, the composition comprises, by weight:
(a) from 30% to 85% by weight, for example from 33% to 83% by weight, in particular from 50% to 78.9% by weight, of at least one semicrystalline aliphatic polyamide having an inherent viscosity between from 1.2 to 1.6, notably from 1.2 to 1.5, in particular from 1.3 to 1.5, notably strictly less than 1.5, notably ranging from 1.30 to 1.48, as determined according to the standard ISO 307:2007 but using m-cresol instead of sulfuric acid, a temperature of 20° C. and a concentration of 0.5% by weight,
(b) from 10% to 30% by weight, for example from 10% to 25% by weight, for example from 14% to 25% by weight, for example from 14% to 22% by weight, for example from 17% to 22% by weight, for example from 14% to 20% by weight, of at least one phosphinate flame retardant,
(c) from 5% to 20%, in particular from 5% to 15%, of at least one functionalized polyolefin,
(d) from 2% to 8% by weight, in particular from 2% to 6% by weight, of at least one plasticizer,
(e) from 0 to 10% by weight, in particular from 0.1% to 5% by weight, of at least one additive,
said composition excluding PA12 and the sum of the constituents (a) to (e) being equal to 100% by weight.

In one embodiment, said composition comprises, by weight:
(a) from 50% to 78.9% by weight, of at least one semicrystalline aliphatic polyamide having an inherent viscosity between from 1.2 to 1.6, notably from 1.2 to 1.5, in particular from 1.3 to 1.5, notably strictly less than 1.5, notably ranging from 1.30 to 1.48, as determined according to the standard ISO 307:2007 but using m-cresol instead of sulfuric acid, a temperature of 20° C. and a concentration of 0.5% by weight,
(b) from 10% to 30% by weight, for example from 10% to 25% by weight, for example from 14% to 25% by weight, for example from 14% to 22% by weight, for example from 17% to 22% by weight, for example from 14% to 20% by weight, of at least one phosphinate flame retardant,
(c) from 5% to 20%, in particular from 5% to 15%, of at least one functionalized polyolefin,
(d) from 2% to 8% by weight, in particular from 2% to 6% by weight, of at least one plasticizer,
(e) from 0 to 10% by weight, in particular from 0.1% to 5% by weight, of at least one additive,
said composition excluding PA12 and the sum of the constituents (a) to (e) being equal to 100% by weight.

In another embodiment, said composition comprises, by weight:
(a) from 50% to 78.9% by weight, of at least one semicrystalline aliphatic polyamide having an inherent viscosity between from 1.2 to 1.6, notably from 1.2 to 1.5, in particular from 1.3 to 1.5, notably strictly less than 1.5, notably ranging from 1.30 to 1.48, as determined according to the standard ISO 307:2007 but using m-cresol instead of sulfuric acid, a temperature of 20° C. and a concentration of 0.5% by weight,
(b) from 10% to 30% by weight, for example from 10% to 25% by weight, for example from 14% to 25% by weight, for example from 14% to 22% by weight, for example from 17% to 22% by weight, for example from 14% to 20% by weight, of at least one phosphinate flame retardant,
(c) from 5% to 15% by weight of at least one functionalized polyolefin,
(d) from 2% to 8% by weight, in particular from 2% to 6%, of at least one plasticizer,
(e) from 0 to 10% by weight, in particular from 0.1% to 5% by weight, of at least one additive,
said composition for example excluding PA12 and the sum of the constituents (a) to (e) being equal to 100% by weight.

In yet another embodiment, said composition comprises, by weight:
(a) from 50% to 78.9% by weight, of at least one semicrystalline aliphatic polyamide having an inherent viscosity between from 1.2 to 1.6, notably from 1.2 to 1.5, in particular from 1.3 to 1.5, notably strictly less than 1.5, notably ranging from 1.30 to 1.48, as determined according to the standard ISO 307:2007 but using m-cresol instead of sulfuric acid, a temperature of 20° C. and a concentration of 0.5% by weight,
(b) from 10% to 30% by weight, for example from 10% to 25% by weight, for example from 14% to 25% by weight, for example from 14% to 22% by weight, for example from 17% to 22% by weight, for example from 14% to 20% by weight, of at least one phosphinate flame retardant,
(c) from 5% to 15% by weight of at least one functionalized polyolefin,
(d) from 2% to 8% by weight, in particular from 2% to 6% by weight, of at least one plasticizer,
(e) from 0% to 10% by weight, in particular from 0.1% to 5% by weight, of at least one additive,
said composition for example excluding PA12 and the sum of the constituents (a) to (e) being equal to 100% by weight.

In yet another embodiment, said composition comprises, by weight:
(a) from 50% to 78.9% by weight, of at least one semicrystalline aliphatic polyamide having an inherent viscosity between from 1.2 to 1.6, notably from 1.2 to 1.5, in particular from 1.3 to 1.5, notably strictly less than 1.5, notably ranging from 1.30 to 1.48, as determined according to the standard ISO 307:2007 but using m-cresol instead of sulfuric acid, a temperature of 20° C. and a concentration of 0.5% by weight,
(b) from 10% to 30% by weight, for example from 10% to 25% by weight, for example from 14% to 25% by weight, for example from 14% to 22% by weight, for example from 17% to 22% by weight of at least one phosphinate flame retardant,
(c) from 5% to 15% by weight of at least one functionalized polyolefin,
(d) from 2% to 8% by weight, in particular from 2% to 6% by weight, of at least one plasticizer,
(e) from 0.1% to 5% by weight of at least one additive,
said composition for example excluding PA12 and the sum of the constituents (a) to (e) being equal to 100% by weight.

In all these embodiments, the invention also covers said compositions in which the term “comprises” is replaced by the term “consisting of”.

The expression “said composition excluding PA12” means, for the purposes of the invention, that the composition comprises less than 5% by weight of PA12, relative to its total weight, notably comprises less than 2% by weight, notably less than 1% by weight, notably less than 0.5% by weight, notably 0% by weight.

In particular, in all the embodiments, the invention also covers compositions for which the sum of the constituents (a) to (e) is equal to 100% by weight.

In a first variant of all these embodiments, said composition is devoid of melamine. It may in particular comprise less than 5% by weight of melamine, notably less than 2% by weight of melamine, or even 0% by weight of melamine, relative to the total weight of said composition.

Melamine is understood to mean both melamine and melamine cyanurate or a nitrogen compound based on melamine.

It is obvious that in this case, the flame retardant cannot be melamine or melamine cyanurate or a nitrogen compound based on melamine.

The presence or absence of melamine depends on the processing temperature of the product and in the case of a high temperature, melamine will be too temperature sensitive.

The use of melamine as flame retardant is not possible during the processing of polymers as targeted according to the invention, namely semicrystalline aliphatic polymers having an inherent viscosity of between 1.2 and 1.6, notably from 1.2 to 1.5, in particular from 1.3 to 1.5, notably strictly less than 1.5, as determined according to the standard ISO 307:2007 but using m-cresol instead of sulfuric acid, a temperature of 20° C. and a concentration of 0.5% by weight.

The processing conditions of such semicrystalline aliphatic polymers, in particular in terms of temperature and/or shear, specifically lead to degradation of such flame retardants and consequently to insufficient fire resistance properties.

It is therefore not possible to obtain compositions having both the fire resistance properties and the mechanical properties desired according to the invention by using melamine as flame retardant.

On the contrary, the inventors have discovered that only compositions comprising a phosphinate flame retardant (b) made it possible to obtain an improved compromise, in particular optimum, between mechanical strength and fire resistance.

According to one embodiment, the compositions of the invention may comprise less than 50% by weight, notably less than 30% by weight, notably less than 20% by weight, notably less than 10% by weight, notably less than 5% by weight of PEBA as defined above.

In particular, according to one embodiment, a composition of the invention may notably comprise less than 1% by weight of PEBA, notably less than 0.5% by weight of PEBA, or even 0% by weight of melamine, relative to the total weight of said composition.

In a second variant of these embodiments, said composition is devoid of PEBA.

According to one embodiment, the compositions of the invention may comprise less than 40% by weight, notably less than 30% by weight, notably less than 20% by weight, notably less than 10% by weight, notably less than 5% by weight of reinforcing fibers as defined above.

In particular, according to one embodiment, a composition of the invention may notably comprise less than 1% by weight of reinforcing fibers, notably less than 0.5% by weight of reinforcing fibers, or even 0% by weight of reinforcing fibers, relative to the total weight of said composition.

In a third variant of all these embodiments, said composition is devoid of reinforcing fibers.

In a fourth variant of all these embodiments, said composition is devoid of melamine and of PEBA.

In a fifth variant of all these embodiments, said composition is devoid of melamine and of reinforcing fibers.

In a sixth variant of all these embodiments, said composition is devoid of PEBA and of reinforcing fibers.

In a seventh variant of all these embodiments, said composition is devoid of melamine, of PEBA and of reinforcing fibers.

According to one embodiment, the compositions of the invention may comprise less than 50% by weight, notably less than 30% by weight, notably less than 20% by weight, notably less than 10% by weight, notably less than 7.5% by weight, notably less than 5% by weight of PA12 as defined above.

In particular, according to one embodiment, a composition of the invention may notably comprise less than 1% by weight of PA12, notably less than 0.5% by weight of PA12, or even 0% by weight of PA12, relative to the total weight of said composition.

In one embodiment, said composition is intended for a railroad application.

### Regarding the PEBA Possibly Excluded

The polyether block amides (PEBA) are copolymers containing amide units (Ba1) and polyether units (Ba2), said amide unit (Ba1) corresponding to an aliphatic repeating unit chosen from a unit obtained from at least one amino acid or a unit obtained from at least one lactam, or a unit X·Y obtained from the polycondensation:
at least one diamine, said diamine being chosen from a linear or branched aliphatic diamine or an aromatic diamine or a mixture thereof, and
at least one carboxylic diacid, said diacid being chosen from an aliphatic diacid or an aromatic diacid,
said polyether units (Ba2) being obtained in particular from at least one polyalkylene ether polyol, in particular a polyalkylene ether diol.

### Regarding the Reinforcing Fibers Possibly Excluded

The reinforcing fibers may in particular be chosen from reinforcing fibers of mineral, organic or plant origin.

Mention may be made, among the fibers of mineral origin, of carbon fibers, glass fibers, basalt fibers or basalt-based fibers, silica fibers or silicon carbide fibers, for example. Mention may be made, among the fibers of organic origin, of fibers based on thermoplastic or thermosetting polymer, such as semiaromatic polyamide fibers, aramid fibers or polyolefin fibers, for example. Mention may be made, among the fibers of plant origin, of natural fibers based on flax, hemp, lignin, bamboo, silk, in particular spider silk, sisal, and other cellulose fibers, in particular viscose fibers.

In one embodiment, said composition after processing has a limiting oxygen index (LOI)>28.

According to another aspect, the present invention relates to a tube, in particular a partially corrugated tube, comprising at least one layer consisting of a composition as defined above.

Said tube may be a single-layer or multilayer tube.

It may be partially smooth or completely smooth.

A smooth tube is used in particular for the circulation of pressurized gas.

It can also be partly corrugated.

A corrugated tube is used in particular to serve as a cable duct.

The expression “partly corrugated” means that the pipe has a corrugated tubular shape over a part of its length. The corrugated part may form a single portion or several portions of the structure, in which case two corrugated portions are separated by a smooth portion.

The corrugated part(s) make(s) it possible to increase the deformation and extension capacity of the tubular structure, especially in areas where small angles are required.

Advantageously, the tubular structure is corrugated over at least 10% of its length.

Advantageously, the tubular structure is corrugated over a proportion between from 10% to more than 90% of its length.

Advantageously, the tubular structure is corrugated over a proportion of from 20% to 90% of its length.

Advantageously, the tubular structure is corrugated over a proportion of from 30% to more than 90% of its length.

Advantageously, the tubular structure is corrugated over a proportion of from 40% to more than 90% of its length.

Advantageously, the tubular structure is corrugated over a proportion of from 50% to more than 90% of its length.

Advantageously, the tubular structure is corrugated over a proportion of from 60% to more than 90% of its length.

Advantageously, the tubular structure is corrugated over a proportion of from 70% to more than 90% of its length.

Advantageously, the tubular structure is corrugated over a proportion of from 80% to more than 90% of its length.

Advantageously, the tubular structure is corrugated over a proportion of more than 90% of its length.

According to yet another aspect, the present invention relates to the use of a composition as defined above for the manufacture of flame-retardant articles for the railroad sector, in particular for trains.

Advantageously, said articles are intended for the interior or exterior of trains.

In one embodiment, the articles are obtained by extrusion.

Advantageously, the article obtained by extrusion is a corrugated tube used as a a cable duct or a smooth tube allowing the circulation of pressurized fluid, in particular pressurized gas, notably compressed air.

According to another aspect, the present invention relates to the use of a composition as defined above, for the protection of a component consisting entirely or partly of metal.

Preferably, the invention relates to this use for imparting electrical insulation and anti-corrosion properties to the metal-based material to which it is applied.

For the purposes of the present invention, the term “metal-based material” is intended to mean metal elements made completely or partly of metal or else plastic or elastic materials comprising metal fibers.

Consequently, the use according to the invention aims to impart electrical insulation and anti-corrosion properties to a component comprising a part comprising metal, in which said part is coated with said copolymer.

These elements may have very diverse shapes: cable, rope, tube, container, film or plate, preferably a tube.

According to yet another aspect, the present invention relates to a process for preparing an article for the railroad sector comprising a step of extruding a composition as defined above.

### EXAMPLES

The compositions in table 1 were prepared by melt blending polymer granules with flame retardants, polyolefins, plasticizers and additives. This blending was carried out by compounding on a corotating twin-screw extruder with a diameter of 40 mm with a flat temperature profile (T°) at 250° C. The screw speed is 300 rpm and the throughput is 70 kg/h.

The polyamide(s), the polyolefins and the additives are introduced during the compounding process in the main hopper. The flame retardant is added to the molten polymer, in the middle of the screw via a side feeder. The plasticizer is also introduced into the molten polymer via a pump.

The compositions were then injection molded at a temperature of 250° C. to obtain the samples to be tested.

The compositions (samples) of the invention and comparative compositions were tested with a limiting oxygen index measurement carried out according to standard ISO 4589-2:2017 on test specimens measuring 80×10×4 mm.

The smoke density during combustion is measured according to standard ISO 5659-2:2017 on plates measuring 75×75×1 mm. The maximum opacity is recorded during a combustion of 10 min.

The smoke toxicity is measured according to standard NF X70-100-1:2006 on a 30 g sample at a temperature of 600° C.

The inherent viscosity (IV) was determined according to standard ISO 307:2007, but using m-cresol instead of sulfuric acid, a temperature of 20° C. and a concentration of 0.5% by weight.

The impact strength was determined according to ISO 179:1eA: 2010 (Charpy impact) on notched bars with dimensions of 80 mm×10 mm×4 mm, at a temperature of 23° C.±2° C. under a relative humidity of 50%±10% or at −30° C.±2° C. under a relative humidity of 50%±10%, on dry samples.

The tensile modulus, the stress at 50% strain, the breaking stress and the elongation at break were measured at 23° C. according to standard ISO 527-1: 2012 on dry samples. For the applications targeted by the invention, the target properties are: modulus<1200 MPa, elongation at break>100%, stress at 50% strain<40 MPa, breaking stress<50 MPa.

The machine used is of INSTRON 5966 type. The speed of the crosshead is 1 mm/min for the measurement of the modulus and 50 mm/min for the stress at 50% strain and breaking stress and the elongation at break. The test conditions are 23° C.±2° C., on dry samples.

The fatigue strength is measured by a Ross flex test on 10 unnotched bars measuring 150×20×2 mm. The measurement was carried out as follows:
Number of cycles: 400 000
Temperature: −10° C.
Bending frequency: 100 cycles/min
Bending angle: 60°
Conditioning of the test specimens: 7 days at 70° C.

After 400 000 cycles, the bars obtained from the formulations of the invention E1 to E6 are not broken, whereas those obtained from comparative compositions CE1, CE3 and CE4 are.

TABLE 1

| Reference | E1 | E2 | E3 | E4 | E5 | E6 |
|---|---|---|---|---|---|---|
| PA11 (IV = 1.45) | 68.8 | 60.8 | 65.8 | 68.8 | 73.8 | 68.8 |
| Orevac ® IM800 | 10 | 12 | 8 | 8 | 4 | 5 |
| Lotader ® AX8900 | | 3 | 2 | 2 | 1 | |
| Renol ® black AF | 2 | 2 | 2 | 2 | 2 | 2 |
| 34132010-ZA | | | | | | |
| Anox ® TL 91 | 1.2 | 1.2 | 1.2 | 1.2 | 1.2 | 1.2 |
| Exolit ® OP1311 | 15 | 18 | 15 | 15 | 15 | 20 |
| BBSA | 3 | 3 | 6 | 3 | 3 | 3 |
| LOI (%) | 29 | 28 | 29 | 29 | 29 | 30 |
| Smoke density | <300 | <300 | <300 | <300 | <300 | <300 |
| (Ds max) | | | | | | |
| Smoke toxicity | <0.9 | <0.9 | <0.9 | <0.9 | <0.9 | <0.9 |
| (CIT_{NLP}) | | | | | | |
| Notched impact | No | No | No | No | No | No |
| according to ISO | breakage | breakage | breakage | breakage | breakage | breakage |
| 179: 1eA at 23° C., | | | | | | |
| resilience (kJ/m²) | | | | | | |
| Notched impact | 7 | 8 | 6 | 7 | 7 | 6 |
| according to ISO | | | | | | |
| 179: 1eA at −30° C., | | | | | | |
| resilience (kJ/m²) | | | | | | |
| Ross flex - | No | No | No | No | No | No |
| unnotched - 400 000 | breakage | breakage | breakage | breakage | breakage | breakage |
| cycles | | | | | | |
| Tensile modulus | 1010 | 870 | 600 | 810 | 1030 | 1050 |
| (MPa) ISO 527-1: | | | | | | |
| 2012 | | | | | | |
| Stress at 50% | 26.7 | 23.4 | 23.7 | 27.0 | 30.5 | 31.3 |
| elongation (MPa) | | | | | | |
| Tensile strength | 26.9 | 25.1 | 27.1 | 27.9 | 35.2 | 33.4 |
| (MPa) | | | | | | |
| Elongation at break | 206 | 186 | 188 | 173 | 157 | 152 |
| (%) | | | | | | |

TABLE 2

| Reference | CE1 | CE2 | CE3 | CE4 | CE5 | CE6 | CE7 |
|---|---|---|---|---|---|---|---|
| PA11 (IV = 1.45) | | | 48.8 | 61.8 | 68.8 | 72.8 | 71.8 |
| PA11 (IV = 1.1) | 68.8 | | | | | | |
| PA11 (IV = 1.8) | | 68.8 | | | | | |
| Orevac ® IM800 | 8 | 8 | 8 | 5 | 8 | 8 | 8 |
| Lotader ® AX8900 | 2 | 2 | 2 | | 2 | 2 | 2 |
| Renol ® black AF | 2 | 2 | 2 | 2 | 2 | 2 | 2 |
| 34132010-ZA | | | | | | | |
| Anox ® TL 91 | 1.2 | 1.2 | 1.2 | 1.2 | 1.2 | 1.2 | 1.2 |
| Exolit ® OP1311 | 15 | 15 | 32 | 20 | | 8 | 15 |
| Melapur MC25 | | | | | 15 | | |
| BBSA | 3 | 3 | 6 | 10 | 3 | 6 | 0 |
| LOI (%) | 28 | Not | 31 | 29 | Not | <28 | 30 |
| Modulus (MPa) | <1200 | extrudable | <1200 | <1200 | extrudable | <1200 | 1530 |
| Notched impact | No | and/or at | No | No | and/or at | No | No |
| according to ISO | breakage | least partial | breakage | breakage | least partial | breakage | breakage |
| 179: 1eA at 23° C., | | degradation | | | degradation | | |
| resilience (kJ/m²) | | of the flame | | | of the flame | | |
| Notched impact | 3 | retardant | 2 | 3 | retardant | 9 | 9 |
| according to ISO | | | | | | | |
| 179: 1eA at −30° C., | | | | | | | |
| resilience (kJ/m²) | | | | | | | |
| Ross flex - | breakage | | breakage | breakage | | No | No |
| unnotched - 400 000 | | | | | | breakage | breakage |
| cycles | | | | | | | |

Orevac ® IM800: Maleic anhydride grafted VLDPE (very low density polyethylene) (SK functional polymer).
Lotader ® AX8900: copolymer of ethylene, methyl acrylate and glycidyl methacrylate (Et/MA/GMA - 68/24/8 by weight) (SK functional polymer).
Renol ® black AF 34132010-ZA: black masterbatch sold by Clariant.
Anox ® TL 91: antioxidant sold by SI group.
Exolit ® OP1311 is a Clariant product (flame retardant based on aluminum diethyl phosphinate).
Melapur MC25 is a BASF product (melamine cyanurate-based flame retardant)
BBSA (benzyl butyl sulfonamide)

Fire resistance: The EN 45545 standard sets various specifications depending on the material category. Polyamide tubes correspond to categories R22 and R23 with the following fire requirements (table 3):

TABLE 3

| Re- | | Units | | | | |
|---|---|---|---|---|---|---|
| quire- | | of the | Min/ | | | |
| ment | Test method | parameter | Max | HL1 | HL2 | HL3 |
| R22 | Limiting oxygen | O2 content | Min | 28 | 28 | 32 |
| | index (LOI) | (%) | | | | |
| | Smoke density | Ds max | Max | 600 | 300 | 150 |
| | Toxicity | CIT_{NLP} | Max | 1.2 | 0.9 | 0.75 |
| R23 | Limiting oxygen | O2 content | Min | 28 | 28 | 32 |
| | index (LOI) | (%) | | | | |
| | Smoke density | Ds max | Max | N/A | 600 | 300 |
| | Toxicity | CIT_{NLP} | Max | N/A | 1.8 | 1.5 |

The products are therefore classified according to their limiting oxygen index and the smoke density and toxicity that they generate during combustion. Three hazard level classifications HL1, HL2 or HL3 can be achieved depending on their fire properties.

The higher this classification, the more the polyamide grade can be used in a large type of train, whereas a product classified as HL1 cannot be used in an underground subway train, for example.

CIT: Conventional toxicity index.

The examples show in particular the influence of the inherent viscosity and also the influence of the range of plasticizer and other constituents on the mechanical criteria and in particular for fatigue strength and cold impact.

Corrugated tubes with an external diameter of 32 mm were extruded at 230° C. with the formulations of examples E1 to E6 according to the invention. These confirm the mechanical performance and fire resistance of these products.

1. A flame-retardant composition comprising, by weight:
(a) from 30% to 85% by weight of at least one semicrystalline aliphatic polyamide having an inherent viscosity ranging from 1.2 to 1.6, as determined according to the standard ISO 307:2007 but while using m-cresol instead of sulfuric acid, a temperature of 20° C. and a concentration of 0.5% by weight,
(b) from 10% to 30% by weight of at least one phosphinate flame retardant,
(c) from 5% to 20% of at least one functionalized polyolefin,
(d) from 2% to 8%, of at least one plasticizer,
(e) from 0 to 10% of at least one additive.

2. The composition as claimed in claim 1, wherein the semicrystalline aliphatic polyamide (a) is obtained by polycondensation:
of at least one C₆ to C₁₈ amino acid, or
of at least one C₆ to C₁₈ lactam, or
of at least one C₄-C₃₆ diamine X with at least one C₄-C₃₆ dicarboxylic acid Y.

3. The composition as claimed in claim 1, wherein the polyamide is a long-chain polyamide having a number of carbons per nitrogen atom of greater than or equal to 8.

4. The composition as claimed in claim 3, wherein said long-chain polyamide is chosen from PA610, PA612, PA1010, PA1012 and PA11.

5. The composition as claimed in claim 4, wherein said at least one semicrystalline aliphatic polyamide is chosen from PA1010, PA1012 and PA11.

6. The composition as claimed in claim 1, wherein the flame retardant is a metal salt chosen from a metal salt of phosphinic acid, a metal salt of diphosphinic acid, a polymer containing at least one metal salt of phosphinic acid and a polymer containing at least one metal salt of diphosphinic acid.

7. The composition as claimed in claim 1, wherein the additives are chosen from antioxidants, colored pigments and flame retardancy synergists.

8. The composition as claimed in claim 1, wherein it is free of polyether block amides (PEBA).

9. The composition as claimed in claim 1, wherein it is free of reinforcing fibers.

10. The composition as claimed in claim 1, comprising, by weight:
(a) from 33% to 83% of at least one semicrystalline aliphatic polyamide having an inherent viscosity between from 1.2 to 1.6, as determined according to the standard ISO 307:2007 but while using m-cresol instead of sulfuric acid, a temperature of 20° C. and a concentration of 0.5% by weight,
(b) from 10% to 25% by weight of at least one phosphinate flame retardant,
(c) from 5% to 20% of at least one functionalized polyolefin,
(d) from 2% to 8% of at least one plasticizer,
(e) from 0 to 10% of at least one additive,
said composition excluding PA12 and the sum of the constituents (a) to (e) being equal to 100% by weight.

11. A tube comprising at least one layer consisting of a composition as defined in claim 1.

12. A method comprising using a composition as defined in claim 1 for the manufacture of flame-retardant articles for the railroad sector.

13. The method as claimed in claim 11, wherein the articles are intended for the interior or exterior of trains.

14. The method as claimed in claim 12, wherein the articles are obtained by extrusion.

15. The method as claimed in claim 14, wherein the article obtained by extrusion is a corrugated tube used as cable duct or a smooth tube allowing the circulation of pressurized gas.

16. A method comprising using a composition as defined in claim 1, for the protection of a part consisting completely or partly of metal.

17. A process for preparing an article for the railroad sector comprising a step of extruding a composition as defined in claim 1.
